(19) United States
(12) Patent Application Publication
(10) Pub. No.: US 2009/0038137 A1
(43) Pub. Date: Feb. 12, 2009

(54) RIVET TOOL FOR STEEL STUDS

(76) Inventor: Robert D. Hassenzahl, Oxford, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/577,101

(22) PCT Filed: Oct. 14, 2005
(86) PCT No.: PCT/US05/37312

§ 371 Date: Apr. 12, 2007

Related U.S. Application Data
(60) Provisional application No. 60/619,187, filed on Oct. 15, 2004.

(51) Int. Cl. B23P 11/00; E04C 3/04

(52) U.S. Cl. 29/432.1; 52/831

(57) ABSTRACT

An improved method for constructing a steel stud frame wall (10) or other sheet metal joining applications using self-punching rivet fasteners (26). The steel stud frame wall includes discrete members to be joined, such as studs (12) connected to a bottom (or top) track (14). A rivet (26) is driven from the outside and staked on the inner, blind side of the overlapping regions of sheet metal. A leading tip (32) of the rivet (26) punches a chad (54) and is then deformed in a die cavity (40) of a setting tool to lock the formed steel pieces in position. The head (28) of the rivet (26) is pressed into the sheet metal during the setting operation so that a pocket (42) is formed out of the surrounding sheet metal, the pocket (42) having at least two distinct contours (56, 58) formed around the rivet head (28). The pocket (42) allows the rivet head (28) to seat into the outer surface of the sheet metal, thus facilitating a subsequent covering operation with wallboard (98) or the like. The multiple distinct contours (56, 58) of the pocket (42) substantially enhances the joint integrity in both sheer and rotational directions. The punched chad (54) helps avoid the introduction of stress cracks in the sheet metal, thereby enhancing joint integrity. A tool for setting the rivet (26) can be actuated mechanically, pneumatically, hydraulically, electrically, by combustion or any other known process.

### RELATED APPLICATIONS

This invention relates to, and claims the benefit of priority from U.S. Provisional Application No. 60/619,187 filed Oct. 15, 2004.

### BACKGROUND OF THE INVENTION

1. Field of the Invention

The invention relates generally to a method and apparatus for fastening two overlapping sheets of metal with a deformable rivet, and more specifically toward an apparatus and method for fastening steel framing members with a rivet whose head is used to form a multi-contoured pocket in the sheet metal members.

2. Related Art

Steel framing members are used in the construction industry to fabricate walls and other structural elements. Unlike wood, steel framing does not warp, shrink or split. It is not vulnerable to termites or carpenter ants. It will not rot, crumble, or add fuel to a fire. Because of this, and its strength and durability, steel framing has become a standard for commercial construction. Nevertheless, steel framing is used only in an estimated 3-5% of residential building projects. In part, steel framing has not achieved wide-spread acceptance because the required assembly tools and skills are different from those of wood framing, which is a disadvantage for do-it-yourselfers and smaller construction companies.

The primary fastener used in steel framing is the self-drilling screw which takes longer to drive than pneumatically driven nails used in wood framing construction. During the erection of a wall, a construction worker will use a drill motor or other spinning tool to drive screws through two abutting steel studs, track or other sheet metal pieces and thus fix them in position. A drawback of this technique resides in the screw head which is left standing proud of the steel stud, because the screw head is not counter sunk into the sides of the sheet metal. The protruding head presents difficulties when wallboard, for example, drywall or paneling, is applied over the framed wall. Lumps in the wallboard may result, and even damage to the wallboard if not properly handled. If the wallboard is affixed by adhesive, the raised screw heads can create excessive glue joints and thus weaken the construction. Furthermore, installers must be careful not to develop carpal tunnel syndrome as a result of the torque of screw gun when repetitively driving screws into the steel framing members.

Alternative fastening techniques to the self-drilling screw have been proposed for steel frame construction. There have been prior attempts to use a form of pneumatically driven nail in steel framing applications, however the nail head stands proud and quite often the metal members are distorted by the one-sided forces. Such nails must be driven near the web to achieve proper penetration and tight joint. For another example, the sheet metal can be crimped or welded. Another alternative to self-tapping metal screws are rivets which are used to fasten the steel studs in position. For example, U.S. Pat. No. 4,726,504 to Halbert discloses a portable hand-held tool for driving and setting a self-punching rivet for fastening wall studs or other sheet metal components. The Halbert '504 patent poses the same drawbacks, however, as the screw joining technique in that the rivet head stands proud of the sheet metal even after the joining operation is complete. In addition to the unattractive lumps and excessive glue joints created when the fastener head is left standing proud of the steel studs, the strength of the joint is limited to the sheer strength of the fastener alone. Some prior art riveting techniques for sheet metal have proposed to counter sink the rivet head. However these are not simple, self-piercing or self-punching operations and thus not conducive to the portable, construction applications. Likewise, the typical tapered shoulder under the head of a counter-sunk rivet is not nearly as resistant to pull-through as a rivet head having a flat (non-tapered) shoulder under the head, although the flat shoulder type heads are never counter-sunk.

### SUMMARY OF THE INVENTION AND ADVANTAGES

A method for joining at least two overlapping sheets of metal with a deformable rivet is provided. The method comprises the steps of positioning at least two overlapping sheets of metal over an anvil having a die cavity formed therein. Providing a rivet having a leading tip and an enlarged head with a generally flat shoulder under the head. Forcibly driving the leading tip of the rivet through the overlapping sheets of metal and then deforming the leading tip of the rivet. The method includes the step of pressing the shoulder of the rivet into the overlapping sheets of metal to locally bend the sheet metal in at least two contours around the rivet head to perfect the joint.

According to a further aspect of the invention, a method for constructing a steel stud frame wall with rivet fasteners is provided. The method comprises the steps of providing a track having an elongated channel and a pair of sides formed by a continuous, generally C-shaped cross-section. The method further includes providing a stud extending between opposite ends thereof and having at least one elongated leg formed by a continuous, generally C-shaped cross-section. One end of the stud member is inserted into the channel of the track so that the leg of the stud overlaps the side of the track. A rivet having a leading tip and an enlarged head is provided. The head has a generally flat shoulder. The leading tip of the rivet is forcibly driven through the overlapping side and leg, and then the leading tip of the rivet is deformed. The method is characterized by pressing the shoulder of the rivet into the overlapping side and leg whereby the side of the track is locally bent in at least two contours by the shoulder to perfect the joint.

Yet another aspect of the invention is a steel stud frame wall joined with self-punching rivet fasteners. The stud wall comprises a track having an elongated channel and at least one elongated side formed by a continuous, generally C-shaped cross-section, the sides each presenting an outer surface. A stud extends between opposite ends thereof and has at least one elongated leg formed by a generally continuous cross-section. One of the stud ends is disposed in the channel of the track such that the side overlaps the leg. A rivet having a leading tip and an enlarged head forming a generally flat shoulder extends through the overlapping side and leg. The leading tip of the rivet has a plastic deformity in pressing contact with the stud leg to resist pull-out. The steel stud frame wall is characterized by a locally depressed pocket in the overlapping side and leg about the rivet head. The pocket comprises at least two non-continuous annular surface contours formed in the outer surface. The shoulder of the rivet head remains in surface contact with the outer surface and with at least one of the surface contours.

The subject apparatus and method provides an efficient method of joining steel framing members using self-punching rivets which are easier and faster than prior art fastening methods, and which can be counter-sunk by deforming the sheet metal around the head of the self-punching rivet so as to improve the strength of the joint. A sheet metal joint made according to the subject invention provides both the flush mounting advantages found in counter-sunk rivet applications and also the strength and pull-through resistance found in traditional flat-headed rivet applications. Furthermore, less glue and therefore glue thickness is required to achieve good bonding between wall-board and the framing members because the rivet head is recessed.

### BRIEF DESCRIPTION OF THE DRAWINGS

These and other features and advantages of the present invention will become more readily appreciated as the same becomes better understood by reference to the following detailed description when considered in connection with the accompanying drawings, wherein:

FIG. 1 is a perspective view of a typical wall constructed of steel studs and depicting a manual apparatus for driving and setting a rivet according to the invention;

FIG. 2 is a cross-section taken generally along lines 2-2 of FIG. 1;

FIGS. 3-5 illustrate a progression of events beginning with a rivet poised for driving through multiple pieces of sheet metal, then being driven through the multiple pieces of sheet metal, and finally having its leading tip deformed within the die cavity of an anvil and its head counter-sunk into a formed pocket so that it rests flush with the outer surface of the steel framing member;

FIG. 6 is a side elevation view of a mechanically actuated apparatus for driving and setting a rivet according to the invention;

FIG. 7 is an enlarged, fragmentary view as in FIG. 6 showing a rivet loaded in the mechanical apparatus and poised for driving through two pieces of sheet metal;

FIG. 8 is a simplified cross-sectional view of a pneumatically actuated apparatus for driving and setting a rivet according to the invention;

FIG. 9 is a simplified cross-sectional view of an alternative hydraulically actuated apparatus for driving and setting a rivet according to the invention; and

FIG. 10 is a cross-sectional view in front elevation showing an anvil of the apparatus of either FIG. 8 or 9 positioned for driving and setting a rivet on the blind side of a bottom track and a metal stud.

### DETAILED DESCRIPTION OF THE PREFERRED EMBODIMENT

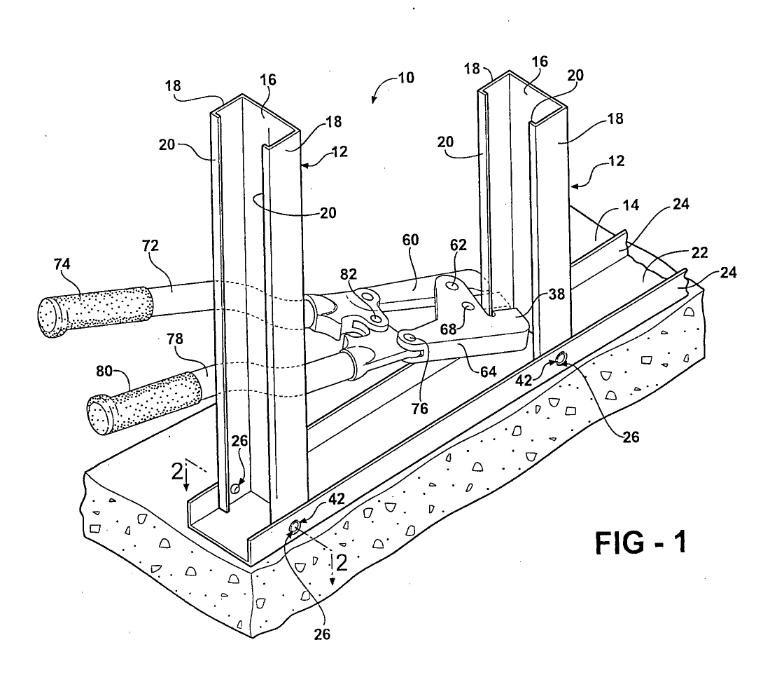

Referring to the Figures, wherein like numerals indicate like or corresponding parts throughout several views, a typical steel frame wall 10 under construction is generally shown in FIG. 1 including vertical studs 12 fastened to a bottom track 14. The studs 12 and bottom track 14 are here used only for illustrative purposes as those skilled in the art will understand that other structural components, such as a top track, cross members, trusses, beams, brackets and the like also made from formed sheet metal can be joined in the same fashion as those components illustrated in FIG. 1. Therefore, while the following description will reference the joining of a stud 12 to a bottom track 14, it must be understood that any other sheet metal joining requirements can be addressed using the method and apparatus of the subject invention.

As is well-known in the art, the studs 12 of a steel frame wall 10 extend between opposite ends thereof and have a generally C-shaped cross-section. This C-shaped cross-section is developed by a web 16 and a pair of legs 18 extending perpendicularly from the web 16. Inward formed flanges 20 extend in opposing relation from the respective legs 18 for increasing the structural rigidity of the stud 12 and for improved handling and worker safety. Those of skill will appreciate that the geometric configuration of stud 12 and track 14 may vary from manufacturer to manufacturer and among differing applications. In addition, the web 16 may be formed with regular openings for plumbing and electrical products, or may be latticed or otherwise trussed to conserve material and improve insulation qualities.

The bottom track 14 has an elongated channel formed by a continuous, generally C-shaped cross-section. Again, the term “continuous” is figurative, and not intended to exclude variations among manufacturers or for structural considerations. The channel is composed of a base 22 and a pair of upstanding sides 24. The inside, perpendicular dimension between sides 24 is slightly larger than the outside dimension across the legs 18 of studs 12 so that a comfortable, clearance fit can be achieved when one end of a stud 12 is placed in the channel of the bottom track 14 so that the sides 24 overlap the legs 18 of the stud 12 as shown in FIG. 1. Subject to local building codes and other design specifics, the studs 12 are generally arranged in regular, spaced intervals along the bottom track 14. A top track, not shown but corresponding in structure to the bottom track 14, joins the top end of the studs 12 in like manner. Doorways, windows, and other features can be framed into the wall 10 construction in known manner.

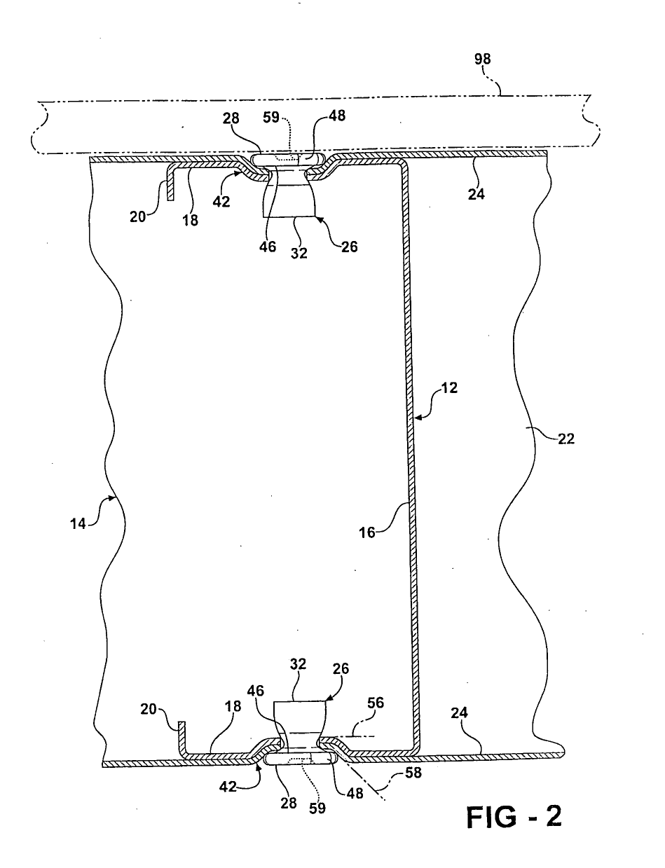

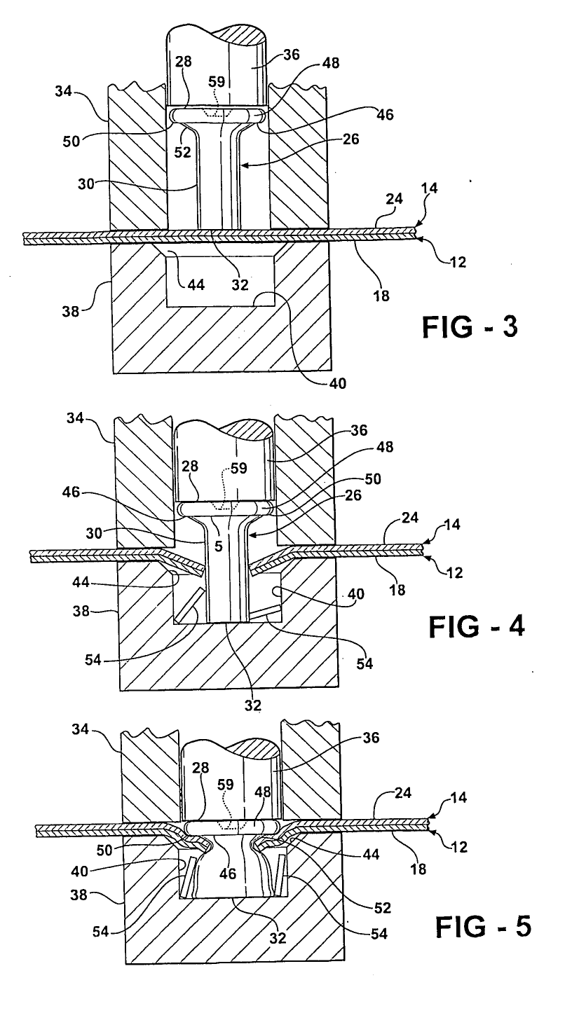

The stud 12 and bottom track 14 are joined together with a self-punching rivet, generally indicated at 26, in the region of their overlap. As perhaps best shown in FIG. 2, the rivet 26 has a generally circular flat head but radiused 28 and a generally cylindrical shank 30 having a flat leading tip 32. FIGS. 3 and 4 depict the rivet 26 in its pre-set condition, whereas the final set condition of the rivet 26 is depicted FIGS. 2 and 5, where the leading tip 32 is deformed by overwhelming compression into a flattened or mushroomed shape which bears in pressing contact with the inner surface of the leg 18 of the stud 12.

FIGS. 1, 6 and 7 illustrate, by way of example, one proposed apparatus for joining the overlapping sheets of metal such as during the construction of a steel frame wall 10. The apparatus includes a magazine 34 dimensioned to slideably receive the head 28 of the rivet 26. A plunger 36 slides within the magazine 34 and acts upon the head 28 of the rivet 26 in the magazine 34. An anvil 38 is supported opposite the magazine 34 and the plunger 36. The anvil 38 includes a die cavity 40 aligned below the leading tip 32 of the rivet 26 when positioned in the magazine 34. Preferably, the anvil 38 contains the die cavity 40 but no moving parts, thereby reducing complexity of design.

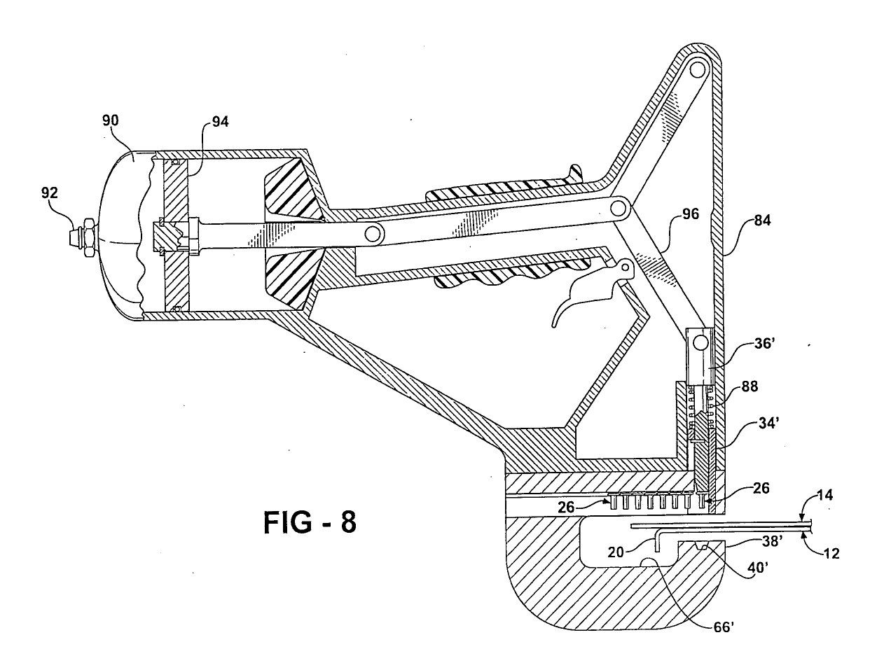

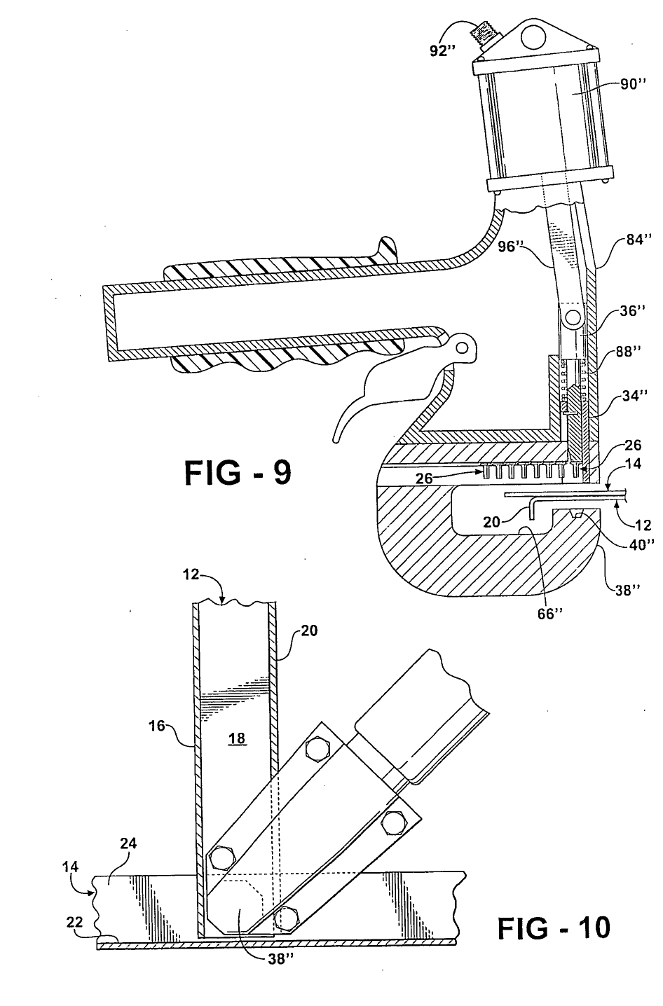

The force required to drive the plunger 36 can come from any suitable source, including manual force, pneumatic or hydraulic pressure, electric motor, linear combustion motor, or any other suitable device. In FIGS. 1, 6 and 7, manual force is indicated whereas in FIG. 8 pneumatic pressure and in FIG. 9 hydraulic pressure, by way of examples only.

In operation, the rivet driving tool of FIGS. 1, 6 and 7 is positioned relative to the end of the stud 12 where it overlaps the bottom track 14 so that its magazine 34 and anvil 38 sandwich the overlapping pieces of sheet metal. The magazine 34 is pressed against the anvil 38 (or the anvil 38 is drawn against the magazine 34) to clamp the sheet metal relative to the driving tool. With a rivet 26 loaded in the magazine 34, a force is applied to drive the plunger 36 against the head 28 of the rivet 26. With sufficient force applied, the leading end 32 punches a hole through both (or all) pieces of sheet metal and continues driving against the bottom of the die cavity 40 in the anvil 38. With continued force applied by the plunger 36, the leading tip 32 is deformed and the head 28 is pushed against the sheet metal causing the sheet metal to form a pocket, generally indicated at 42, in a local region surrounding the rivet head 28.

Referring now to the sequence of rivet setting illustrated in FIGS. 3, 4 and 5, a cross-section through the magazine 34 and die cavity 40 depicts two overlapping sheets of metal which, in the exemplary embodiment of this invention, may comprise the leg 18 and side 24 of a steel frame wall 10 construction. The die cavity 40 is shown including a chamfered or radiused mouth 44 which is sized and positioned, relative to the rivet head 28, to allow the sheet metal to flow around the head 28 without tearing. The rivet 26 is also shown in enlarged detail including a flat shoulder 46 forming a ledge below the head 28, and a circular rim 48 extending from the shoulder 46. The intersection between the rim 48 and shoulder 46 is formed by a rounded corner 50. Conversely, the intersection between the shank 30 and the shoulder 46 is formed by a fillet 52.

In the pre-fastened condition shown in FIG. 3, the rivet 26 is poised for a self-punching plunge through the overlapping pieces of sheet metal 18, 24. As the flat leading tip 32 of the rivet 26 punches through the sheet metal, loose circular portions of sheet metal may be formed, resulting in either a loose chad 54 (FIG. 4) or a hanging chad (not shown). In either event, there is sufficient room provided in the die cavity 40 to accommodate the chad 54, be it loose or hanging. By cleanly punching out the chad 54, as opposed to a pointed tip piercing operation, radial cracks are avoided in the sheet metal, which helps improve joint integrity.

In FIG. 4, the driven rivet 26 is shown having punched through the overlapping pieces of sheet metal 18, 24, and its leading tip 32 bottoming within the die cavity 40 prior to the shoulder 46 making contact with the outer surface of the side 24. Continued force applied by the plunger 36 results in axial compression of the rivet shank 30, which expands into a deformity larger than the initial hole punched by the leading tip 32. While the rivet 26 can be made from any suitable material, it is advantageous to select a material whose elastic-plastic yield point can easily be exceeded during the axial compression phase. This “setting” of the rivet 26 thereby resists removal of the rivet 26 and disconnection of the overlapping pieces of sheet metal.

When the plunger 36 reaches its full, extended stroke as shown in FIG. 5, the shoulder 46 of the rivet 26 is pressed into the overlapping side 24 and leg 18 resulting in the locally bent pocket 42 in which at least two surface contours are generated in the overlapping sheet metal by the shoulder 46. As depicted by the extension lines in FIG. 2, the two overlapping surfaces may be composed of a generally flat annulus 56 corresponding to the shoulder 46 and a generally frustoconical bowl 58 extending from the annulus 56 out to the generally planer outer surface of the side 24. Thus, the annulus 56 and bowl 58 surfaces comprise two distinct contours which are followed by both (or all) of the overlapping pieces of sheet metal. In other words, if more than two pieces of sheet metal are joined using the method of this invention, all overlapping pieces of sheet metal will be locally bent into the pocket 42 with all of the layers following the multiple contours created by the flat shoulder 46 coupled with the rim 48. Depending upon the specific shape of the rivet head 28 and the corresponding die cavity 40, more than two contours may be formed, as suggested in FIG. 5 where three contours are plainly evident (with the third contour being formed along the fillet 52). It will be appreciated that the rounded corner 50 of the rivet head 28, in cooperation with the rim 48, facilitates the formation of these multiple contours in the sheet metal, without cutting or compromising the joint integrity. Furthermore, the dimension and configuration of the chamfered or radiused mouth 44 relative to the size and shape of the rivet head 28 facilitates proper formation of the multiple contours within the sheet metal layers.

In FIGS. 2-5, the rivet head 28 is shown including an exposed dimple 59. The dimple 59 may be centered in the exposed surface of the head 28 and serves as a drilling pilot in case it becomes necessary to remove the rivet 26 after it has been set. Thus, the dimple 59, while very small and not structurally significant, acts as a starter for a drill bit used to drill out the rivet 26.

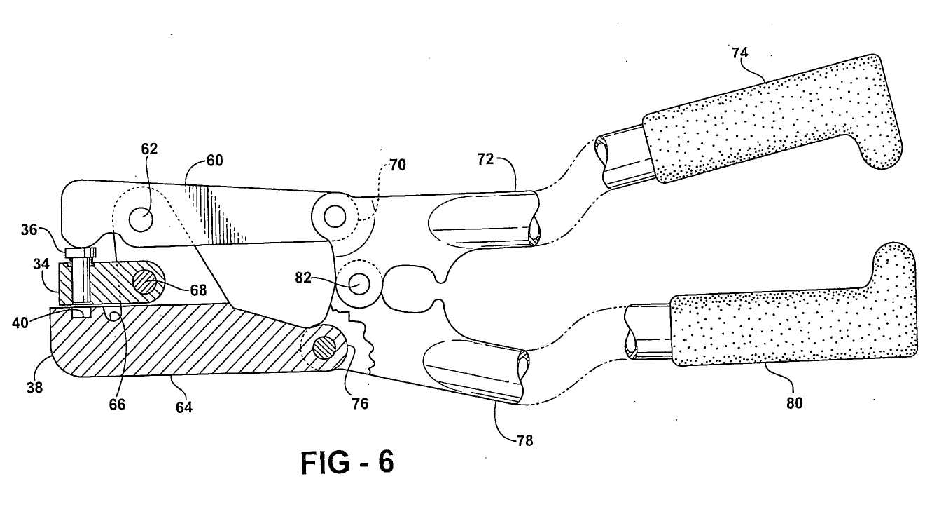

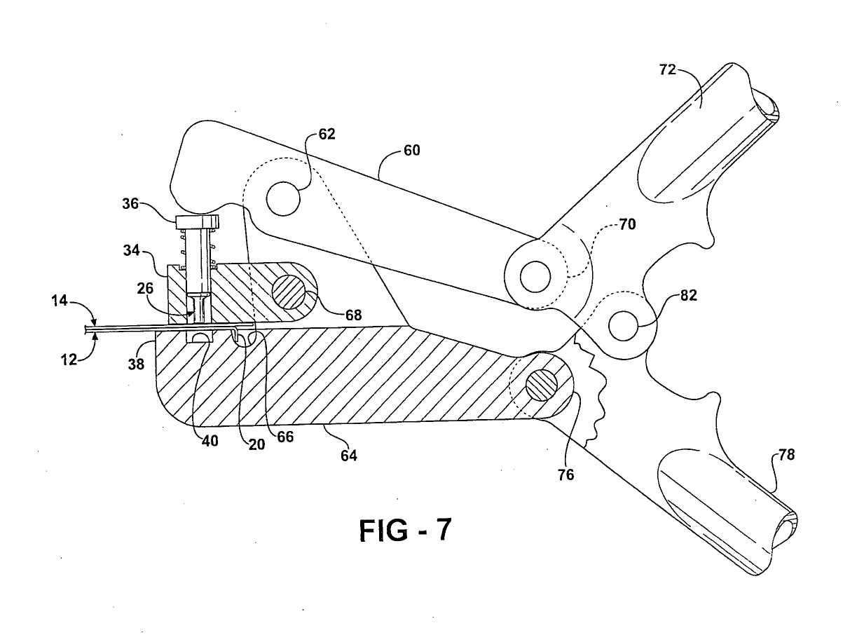

Referring to FIGS. 6 and 7, which depict the mechanically actuated apparatus for driving and setting a rivet 26 according to the invention, a more detailed description of the mechanical components will be described presently. In this embodiment, the setting apparatus comprises a linked and levered tool similar in many respects to a common bolt cutter. In this embodiment, the plunger 36 is controlled by the free cam face end of an upper link 60 which is pivoted at 62. The pivot 62 is carried on a lower jaw 64. The anvil 38 is formed on the lower jaw 64, adjacent a clearance slot 66 provided for the stud flanges 20. In practice, the clearance slot 66 may be wide enough to permit substantial angular variation in the approach of the tool relative to the overlapping joint to be created. See, for example, the approach depicted in FIG. 10. In another configuration, a pair of crossing clearance slots 66 may be formed in the lower jaw 64 at generally 45° angles to the sides of the lower jaw 64 to facilitate a more limited approach into the overlapping joint.

A pin 68 holds the magazine 34 in position over the die cavity 40. The plunger 36 is carried in the magazine 34. The upper link 60 is pivotally joined at its distal end 70 to an upper actuator bar 72. The upper actuator bar 72 may be crooked or bent to provide sufficient clearance during a rivet setting operation, as will be appreciated upon reference to FIG. 1. The upper actuator bar 72 terminates in a grip 74. Similarly, the distal end 76 is pivotally joined to a lower actuator bar 78 which terminates in a grip 80. The lower actuator bar 78 may be formed with a crook to correspond generally with that of the upper actuator bar 72. The upper 72 and lower 78 actuator bars are pivotally joined to each other at hinge point 82.

As shown in FIG. 7, when the upper 72 and lower 78 actuator bars are separated, the upper link 60 is pivoted away from the lower jaw 64, thus withdrawing the plunger 36 to make ready for a riveting operation. In this condition, a rivet 26 held in the magazine 34 is poised to be driven through the overlapping sheet metal components and into the die cavity 40 of the anvil 38. The magazine 34 can be so designed as to hold a plurality of rivets 26 in either strip or track-like fashion to facilitate automatic loading and rapid action. When an operator squeezes together the upper 72 and lower 78 actuator bars, the upper link 60 actuates the plunger 36 which in turn drives against the head 28 of the rivet 26, thus forcing the components through the sequence of events illustrated in FIGS. 3-5.

The mechanically actuated apparatus illustrated in FIGS. 1, 6 and 7 is suggestive only, and those skilled in the art will immediately appreciate that other designs and constructions of mechanically actuated driving apparatus can be configured and employed to achieve the results of this invention which are highlighted by a rivet 26 which is self-punching and whose head 28 is counter-sunk into the surface of the sheet metal by bending and forming the sheet metal in at least two distinct contours in the region under and around the rivet head 28. Furthermore, the mechanically actuated apparatus as depicted in the Figures, while simple in construction, has demonstrated in prototypes the ability to effortlessly stake multiple sheets of overlapping metal 0.050 inches thick. It should be noted that stud 12 and bottom track 14 members as used in typical residential framing of non-load bearing walls 10 will have a steel thickness ranging from 0.018 to 0.033 inches.

In FIG. 8, another alternative embodiment of the subject invention is shown as a pneumatically actuated apparatus for driving and setting a rivet 26 according to the invention. For convenience, single prime reference numbers are used to designate prior described components which have been reconfigured for this application. Specifically, the apparatus in FIG. 8 is shown with its anvil 38′ consisting of a C-shaped jaw-like member attached to a valve body housing 84. Overlapping sheets of metal (either stud 12, bottom track 14, or other sheet metal components) are passed through the throat region so that the magazine 34′ can be moved into a clamping position. Here, the magazine consists of a spring/pressure actuated magazine cylinder 34′. A feeding track readies a reserve of rivets 26 for sequential indexing into the magazine cylinder 34′. In this embodiment, pressurized air is fed into an air chamber 90 via an inlet 92 and trigger device. Fluid pressure in the air chamber 90 acts against a piston 94 which, through linkage 96, actuates the plunger 36′. The clamping spring 88 interposed between the plunger 36′ and the magazine cylinder 34′ is effective to drive and clamp the sheet metal in preparation for the riveting operation, while allowing continued travel of the plunger 36′ toward its fully extended condition.

In operation, an operator positions the pneumatic actuating tool of FIG. 8 relative to sheet metal studs 12 and bottom track 14 (or other sheet metal) as suggested in the depiction of FIG. 10 so that the region to be joined by riveting is presented in the throat of the apparatus, between the anvil 38′ and the magazine cylinder 34′. The operator then actuates a trigger mechanism which simultaneously clamps the sheet metal components together by the advancing magazine cylinder 34′, and then forcibly drives the plunger 36′ against the head 28 of the rivet 26 and through the sequence of events shown in FIGS. 3-5.

Yet another alternative embodiment of the driving tool is depicted in FIG. 9 by way of a hydraulically actuated mechanism. For convenience, double prime reference numbers are used to designate prior described components which have been reconfigured for this application. Here, a hydraulic chamber 90″ receives pressurized fluid through an inlet 92″ and a trigger mechanism to displace a piston (not shown) and thus throw the linkage 96″. In an arrangement similar to that described in connection with FIG. 8, the plunger 36″, acting through a clamping spring 88″ advances a magazine cylinder 34″ to clamp the overlapping pieces of sheet metal 12, 14 against an anvil 38″. Continued movement of plunger 36″ drives a loaded rivet 26 through the sheet metal pieces 12, 14 and sequentially through the setting progression as depicted in FIGS. 3-5. In this embodiment, as with that shown in FIG. 8, the magazine 34″ may be fed by a row of rivets 26 suspended from their respective heads 28 in a T-slot. A spring or other advancing mechanism (not shown) will successively index a new rivet 26 into the magazine cylinder 34″ at the appropriate moment.

Those skilled in the art will readily appreciate many variations and embodiments of tools which will achieve the desired results of joining overlapping pieces of sheet metal using a self-punching rivet 26 whose head 28 is counter-sunk into the surface of the sheet metal 12 and 14 by depressing the sheet metal 14 in a pocket region 42 around the rivet head 28 so that multiple, discrete contours are formed in the sheet metal around the rivet head 28. The pocketing of the rivet head 28 not only establishes a flush (or near flush) outer surface against which wallboard 98 (FIG. 2) can be applied without disruption, but also increases the strength of the joint in sheer and rotational directions. Other variations of the invention, not shown in the drawings, include tapering the shank 30 diameter of the rivet 26 to punch a larger hole and thus allow the punched metal to spring back toward a flat condition before the leading tip 32 of the rivet 26 begins to mushroom. Alternatively, the rivet 26 can be hollow or its leading tip 32 formed with a concavity to improve the mushrooming effect. This may be coupled with a wedge or other feature formed in the die cavity 40 to facilitate a spreading of the rivet shank 30 during the setting operation.

The subject invention provides a single portable (or stationary) piece of equipment which is capable of driving a rivet 26 from one side of the sheet metal 14 and stake it on the other (blind) side of sheet metal 12. This is provided in a single step operation in which two or more pieces of overlapping sheet metal are joined with sufficient integrity to provide a secure mechanical joint. By forming a multi-contoured pocket 42 in which the rivet head 28 is seated into the surface of the exposed sheet metal 14, the joint integrity is substantially enhanced and the rivet 26 is better poised to prevent the sheet metal 12, 14 from separating as the depressed and interlocking pocket section 42 resists shearing.

A key to this invention is providing a die cavity in the anvil that is wide enough and rounded enough to allow the rivet head to depress flush without cutting the metal, yet is shallow enough to stake or deform the rivet shank.

The invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. A method for joining at least two overlapping sheets of metal (12, 14) with a deformable rivet (26), said method comprising the steps of:
overlapping at least two overlapping sheets of metal (12, 14);
providing a rivet (26) having a leading tip (32) and an enlarged head (28), the head (28) having a generally flat shoulder (46);
forcibly driving the leading tip (32) of the rivet (26) through the overlapping sheets of metal (12,14);
deforming the leading tip (32) of the rivet (26) after it has passed through the overlapping sheets of metal (12,14); and
pressing the shoulder (46) of the rivet head (28) into the overlapping sheets of metal (12, 14) whereby the overlapping sheets of metal (12, 14) are locally bent in at least two discontinuous contours by the shoulder (46) to perfect the joint therebetween.

2. The method of claim 1 wherein the rivet (26) is made of a material having an elastic-plastic yield point, said step of deforming the leading tip (32) includes axially compressing the rivet (26) beyond the yield point of the rivet material.

3. The method of claim 1 wherein said step of forcibly driving the rivet (26) includes punching a chad (54) from the overlapping sheets of metal (12, 14) with the leading tip (32).

4. The method of claim 1 wherein said pressing step includes simultaneously deforming the overlapping sheets of metal (12, 14) around the rivet head (28).

5. The method of claim 4 wherein said step of simultaneously deforming the overlapping sheets of metal (12, 14) includes forming nesting circular depressions in the overlapping sheets of metal (12, 14) centered about the rivet head (28), the circular depressions comprising a generally flat annulus (56) corresponding to the shoulder (46) of the rivet head (28) and a generally frustoconical bowl (58) extending outwardly from the annulus (56).

6. A method for constructing a steel stud frame wall (10) with rivets (26), said method comprising the steps of:
providing a track (14) having an elongated channel and a pair of sides (24) formed by a continuous, generally C-shaped cross-section;
providing a stud (12) extending between opposite ends thereof and having at least one elongated leg (18) formed by a continuous, generally C-shaped cross-section;
inserting one end of the stud (12) into the channel of the track (14) such that a side (24) of the track (14) overlaps a leg (18) of the stud (12);
providing a rivet (26) having a leading tip (32) and an enlarged head (28), the head (28) having a generally flat shoulder (46);
forcibly driving the leading tip (32) of the rivet (26) through the overlapping side (24) and leg (18);
deforming the leading tip (32) of the rivet (26); and
pressing the shoulder (46) of the rivet (26) into the overlapping side (24) and leg (18) whereby the side (24) of the track (14) is locally bent in at least two contours by the shoulder (46) to perfect the joint.

7. The method of claim 6 wherein the rivet (26) is made of a material having an elastic-plastic yield point, said step of deforming the leading tip (32) includes axially compressing the rivet (26) beyond the yield point of the rivet material.

8. The method of claim 6 wherein said step of forcibly driving the rivet (26) includes punching a chad (54) from the overlapping sheets of metal (12, 14) with the leading tip (32).

9. The method of claim 6 wherein said pressing step includes simultaneously deforming the overlapping sheets of metal (12, 14) around the rivet head (28).

10. The method of claim 9 wherein said step of simultaneously deforming the overlapping sheets of metal (12, 14) includes forming nesting circular depressions in the overlapping sheets of metal (12, 14) centered about the rivet head (28), the circular depressions comprising a generally flat annulus (56) corresponding to the shoulder (46) of the rivet head (28) and a generally frustoconical bowl (58) extending outwardly from the annulus (56).

11. A steel stud frame wall (10) joined with self-punching rivet fasteners, said stud wall comprising:
a track (14) having an elongated channel and at least one elongated side (24) formed by a continuous, generally C-shaped cross-section, said sides (24) each presenting an outer surface;
a stud (12) extending between opposite ends thereof and having at least one elongated leg (18) formed by a generally continuous cross-section;
one of said ends of said stud (12) disposed in said channel of said track (14) such that a region of said side (24) overlaps a region of said leg (18);
a rivet (26) having a leading tip (32) and an enlarged head (28) forming a generally flat shoulder (46), said rivet (26) extending through the overlapping region of said side (24) and leg (18), said leading tip (32) of said rivet (26) having a plastic deformity in pressing contact with said leg (18) of said stud (12); and
a locally depressed pocket (42) disposed in the overlapping region of said side (24) and leg (18) about said rivet head (28), said pocket (42) comprising at least two non-continuous annular contours (56, 58) formed in said outer surface, and said shoulder (46) of said rivet head (28) remaining in surface contact with said outer surface and with at least one of said surface contours (56, 58).

12. The steel stud frame wall (10) as set forth in claim 11 wherein said head (28) has a generally circular rim (48) extending from said shoulder (46).

13. The steel stud frame wall (10) as set forth in claim 12 further including a rounded corner (50) at the intersection between said rim (48) and said shoulder (46).

14. The steel stud frame wall (10) as set forth in claim 11 wherein said rivet (26) include a generally cylindrical shank (30) extending between said leading tip (32) and said shoulder (46).

15. The steel stud frame wall (10) as set forth in claim 14 further including a fillet (52) at the intersection between said shank (30) and said shoulder (46).

16. The steel stud frame wall (10) as set forth in claim 11 wherein said leading tip (32) of said rivet (26) has a flat, generally circular punching surface.

17. The steel stud frame wall (10) as set forth in claim 11 wherein said head (28) of said rivet (26) includes a dimple (59).
